(19) United States
(12) Patent Application Publication
(10) Pub. No.: US 2025/0194868 A1
(43) Pub. Date: Jun. 19, 2025

(54) SCRUBBER OR THERAPEUTIC DEVICE

(71) Applicant: Joshua Grange, Nashville, TN (US)

(72) Inventor: Joshua Grange, Nashville, TN (US)

(21) Appl. No.: 18/987,132

(22) Filed: Dec. 19, 2024

Related U.S. Application Data
(60) Provisional application No. 63/612,019, filed on Dec. 19, 2023.

(51) Int. Cl. A47K 7/04; B29C 39/02; B29C 39/24; B29K 83/00; B29L 31/00

(52) U.S. Cl. CPC A47K 7/043; B29C 39/021; B29C 39/24; B29K 2083/00; B29L 2031/7406

(57) ABSTRACT

A scrub bar for removing a substance from a user's hands is provided. The scrub bar can include a body and a plurality of nubs. The body can include a top surface, a bottom surface, a front surface, a rear surface, a first side surface, and a second side surface. The plurality of nubs can extend from each of the top surface, the bottom surface, the front surface, the rear surface, the first side surface, and the second side surface. Further, each of the plurality of nubs can extend in a direction away from a center of the body. The scrub bar is configured to remove a substance from a user's hands. In some examples, the substance can be an edible dough and the user can be a baker.

### CROSS REFERENCE TO RELATED APPLICATIONS

This application claims the benefit of U.S. Provisional Application No. 63/612,019 filed on Dec. 19, 2023, which is incorporated by reference as if fully set forth.

### FIELD OF INVENTION

The present disclosure is directed to a device that has applications as: a bakery substance scrubber, and more particularly it is directed to a scrub bar for removing a bakery substance from a user's hands or a surface having a bakery substance on it; or, a therapeutic device, such as used for manipulation by the hands or as a massage device.

### BACKGROUND

When making pastries, breads, pizza crusts, or other similar edibles items, a baker first makes a dough including one or more of flour, liquids, fats, and yeast, among other ingredients not specifically listed. The baker often must mix the ingredients of the dough, knead the dough, allow the dough to ferment and rise, shape the dough, and then proof the dough before baking. During the mixing, kneading, and shaping steps, the baker often uses their hands to directly grasp, handle, and manage the dough. This often results in some of the dough sticking the baker's hands, which can be difficult to remove using water, soap, and/or traditional scrubbers.

As such, there is a need for a scrub bar, scrubber, or cleaning device that aids in easily and efficiently removing dough from baker's hands, reducing the time and effort typically associated with cleaning and removing dough from baker's hands. Such a device can also be used to remove bakery substances such as dough from a surface.

Further, a device having tactile features and a textured surface can be useful in the area of, for example, hand therapy. Through manipulation, such a therapeutic device can be manipulated by the hands, and supply exercise, or relief from arthritis or other pain and inflammation symptoms. In addition, such a device can be used as a massager.

### SUMMARY

According to one aspect, the present disclosure is directed to a scrub bar for removing a substance from a user's hands. The scrub bar can include a body and a plurality of nubs. The body can include a top surface, a bottom surface, a front surface, a rear surface, a first side surface, and a second side surface. The plurality of nubs can extend from each of the top surface, the bottom surface, the front surface, the rear surface, the first side surface, and the second side surface. Further, each of the plurality of nubs can extend in a direction away from a center of the body. Such a bar can also be used to remove bakery substances such as dough from a surface.

In one aspect, the body comprises a rectangular prism shape with each edge and corner of the rectangular prism being rounded.

In one aspect, the body includes a solid or filled interior.

In one aspect, the body includes an upper half and a lower half separated by a medial plane positioned an equal distance from the top surface and the bottom surface of the body, the upper half and the lower half of the body being non-identical or non-mirrored about the medial plane.

In one aspect, the upper half of the body includes between 100 and 125 nubs extending from the upper half of the body, and the lower half of the body includes between 126 and 150 nubs extending from the lower half of the body.

In one aspect, each of the plurality of nubs extend from the body at an angle ranging between 85 degrees and 95 degrees with reference to each individual nubs connection location to the body.

In one aspect, a spacing between each adjacent nub of the plurality of nubs ranges between 1 millimeter and 5 millimeters.

In one aspect, each of the plurality of nubs include a cylindrical shape with a circular cross section viewing in an axial direction of each of the plurality of nubs.

In one aspect, a diameter of each of the plurality of nubs ranges between 1 millimeter and 10 millimeters.

In one aspect, each of the plurality of nubs extend from the body a distance ranging between 1 millimeter and 10 millimeters.

In one aspect, an identification feature can extend from the top surface of the body.

In one aspect, the identification feature includes letters, shapes, symbols, or numbers.

In one aspect, both the body and the plurality of nubs are constructed from a polymeric material.

In one aspect, both the body and the plurality of nubs are constructed from a food-grade silicone material.

In one aspect, the scrub bar is configured to remove a substance from a user's hands.

In one aspect, the substance is an edible dough.

According to another aspect, the present disclosure is directed to a method of producing a scrub bar for removing a substance from a user's hands. The method can include one or more of the following steps: providing a polymeric material and mixing at least one of a colorant or an additive into the polymeric material to create a polymeric mixture; degassing, through a degassing process, the polymeric mixture, and pouring the degassed polymeric mixture into an upper mold and a lower mold; curing the degassed polymeric mixture in the upper mold and the lower mold; joining, through a joining process, the upper mold to the lower mold; and curing the joined upper mold and lower mold to create the scrub bar.

In one aspect, the method further includes, after curing the joined upper mold and lower mold: removing the scrub bar from the upper mold and the lower mold; and trimming excess material positioned along a joining seam of the upper mold and the lower mold to produce a final scrub bar.

In one aspect, the degassing process is performed in a vacuum chamber.

In one aspect, the polymeric material is a food-grade silicone material.

According to another aspect, the present disclosure is directed to a therapeutic device or massager having a design according to aspects discussed herein.

### BRIEF DESCRIPTION OF THE DRAWINGS

The foregoing Summary as well as the following Detailed Description will be best understood when read in conjunction with the appended drawings, which illustrate a preferred embodiment of the disclosure. In the drawings:

FIG. 1 is a perspective view of an exemplary scrub bar or therapeutic device of the present disclosure.

FIG. 2 is a top view of the scrub bar or therapeutic device of FIG. 1.

FIG. 3 is a front view of the scrub bar or therapeutic device of FIG. 1.

FIG. 4 is a side view of the scrub bar or therapeutic device of FIG. 1.

FIG. 5 is a bottom view of the scrub bar or therapeutic device of FIG. 1.

FIG. 6 is another perspective view of the exemplary scrub bar or therapeutic device illustrated in FIG. 1.

FIG. 7 is a cross-sectional view of the scrub bar or therapeutic device taken along Section 7-7 in FIG. 2.

FIG. 8 is a perspective cross-sectional view of the scrub bar or therapeutic device of FIG. 7.

FIG. 9 is a perspective view of a mold assembly utilized to produce the scrub bar or therapeutic device illustrated in FIGS. 1-8.

FIG. 10 is a top view of the mold assembly illustrated in FIG. 9.

FIG. 11 is a flow chart illustrating method steps for producing the scrub bar or therapeutic device illustrated in FIGS. 1-8.

FIG. 12A is a perspective view of a scrub bar or therapeutic device according to another embodiment of the present disclosure.

FIG. 12B is another perspective view of the scrub bar or therapeutic device of FIG. 12A with the nubs illustrated in dashed lines for clarity.

FIG. 13 is a perspective view of a scrub bar or therapeutic device according to yet another embodiment of the present disclosure.

### DETAILED DESCRIPTION OF THE PREFERRED EMBODIMENT(S)

Certain terminology is used in the following description for convenience only and is not limiting. The words “front”, “rear”, “upper”, and “lower” designate directions in the drawings to which reference is made. The words “inwardly” and “outwardly” refer to directions towards and away from parts referenced in the drawings. “Axially” refers to a direction along the axis of an axle, shaft, pin, or the like. A reference to a list of items that are cited as “at least one of a, b, or c” (where a, b, and c represent the items being listed) means any single one of the items a, b, or c, or combinations thereof are included. The terms “about” and “approximately” encompass +/−10% of an indicated value unless otherwise noted. The term “generally” in connection with a radial direction encompasses +/−25 degrees. The terminology includes the words specifically noted above, derivatives thereof and words of similar import.

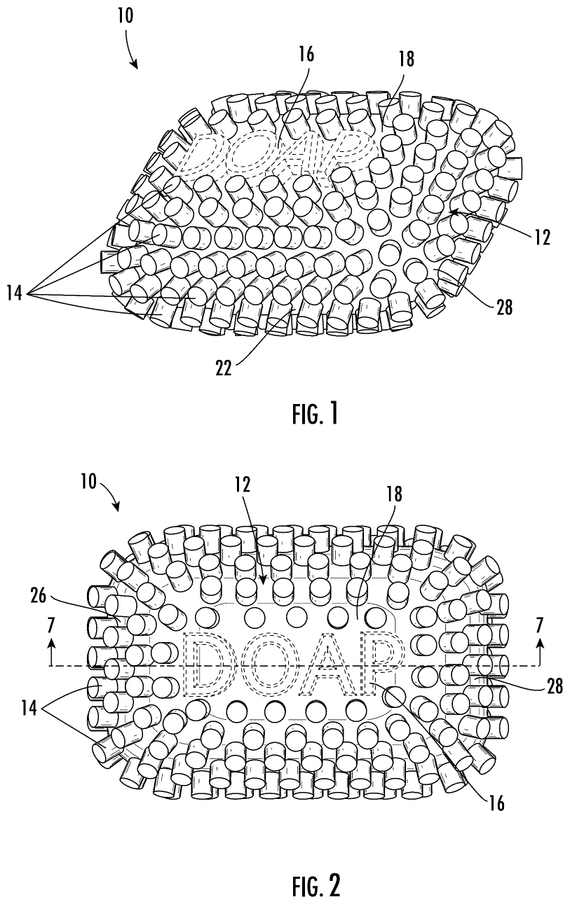

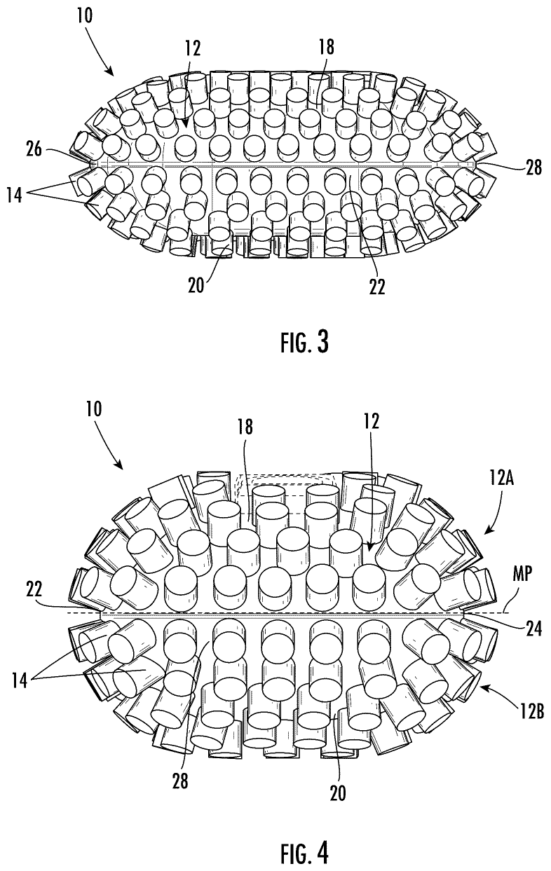

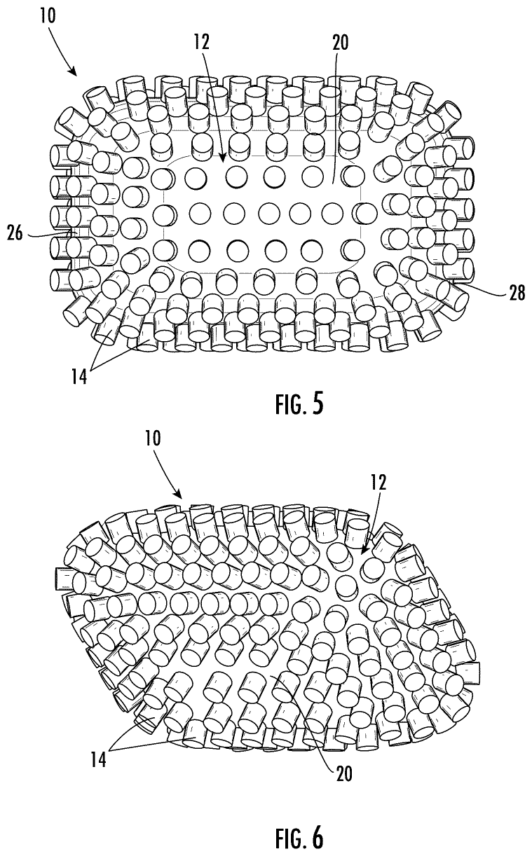

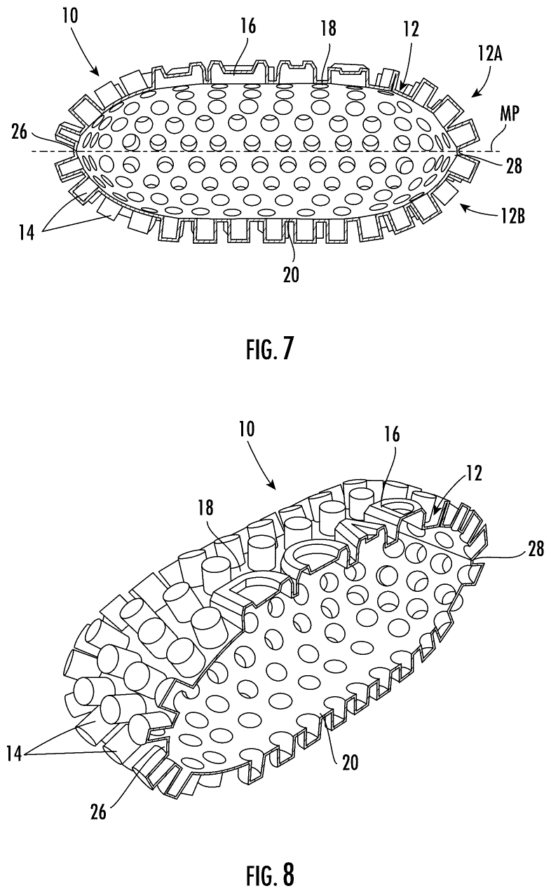

FIG. 1 is a perspective view of an exemplary scrub bar 10 of the present disclosure. FIG. 2 is a top view of the scrub bar 10. FIG. 3 is a front view of the scrub bar 10. FIG. 4 is a side view of the scrub bar 10. FIG. 5 is a bottom view of the scrub bar 10. FIG. 6 is another perspective view of the scrub bar 10. FIG. 7 is a cross-sectional view of the scrub bar 10 taken along Section 7-7 in FIG. 2. FIG. 8 is a perspective cross-sectional view of the scrub bar 10 illustrated in FIG. 7. FIGS. 1-8 will be discussed together.

The scrub bar 10 of the present disclosure is a cleaning device that aids in easily and efficiently removing dough from baker's hands, reducing the time and effort typically associated with cleaning and removing dough from baker's hands. As such, the scrub bar 10 can be described as a “dough soap” for bakers to utilize to clean their hands. As will be discussed, the scrub bar 10 can include a plurality of nubs that are utilized to aid in removing the dough or other substance from the baker's hands. In some examples, the scrub bar 10 can be made from food-grade/food-safe silicone and the scrub bar 10 can be dishwasher safe to aid in ease of use and cleaning. The scrub bar 10 is utilized to quickly and easily remove sticky dough from a baker or user's hands, providing advantages over previous products and techniques for removing dough from a user or baker's hands. It is to be understood that the terms user(s) and baker(s) are used interchangeably throughout the present disclosure, but each refers to the person handling and utilizing the scrub bar 10.

It is appreciated that the “nubs” can be considered or described as extensions, or projections, or similarly described.

Referring to FIGS. 1-8, the exemplary scrub bar 10 includes a body 12 and a plurality of nubs 14. Further, in some examples, the scrub bar 10 can also include an identification feature 16, discussed further below. The body 12 includes a top surface 18, a bottom surface 20, a front surface 22, a rear surface 24, a first side surface 26, and a second side surface 28. It is to be understood that the surfaces of the body 12 are labelled based on the orientation of the scrub bar 10 illustrated in FIG. 1. As such, the surfaces 18, 20, 22, 24, 26, and 28 could also be referred to as the first surface 18, second surface 20, third surface 22, fourth surface 24, fifth surface 26, and sixth surface 28, respectively. For ease of reference, the following disclosure will refer to the surfaces as the top surface 18, the bottom surface 20, the front surface 22, the rear surface 24, the first side surface 26, and the second side surface 28.

The body 12 of the scrub bar 10 can be described as generally having the shape of a rectangular prism with each edge and corner of the rectangular prism being rounded. In other words, the scrub bar 10 includes generally the shape of a standard bar of soap, and may be referred to as “soap-bar-shaped.” A bar of soap typically has a rectangular or oval shape, often with smooth, rounded edges. The surface can be slightly curved or flat, depending on the soap bar. In some aspects of the invention, the body 12 has the shape of a bar of soap. Specifically, in some examples, the scrub bar 10 can have a generally rectangular shape with the length of the scrub bar 10 being greater than the height of the scrub bar 10. Further, in some examples, the body 12 of the scrub bar 10 can be constructed using a molding technique or process, and therefore the body 12 can include a hollow interior (see FIGS. 7-8). In other examples, the body 12 of the scrub bar 10 can be constructed using a different technique, such as 3D printing or other additive manufacturing processes. In addition, in some examples, the body 12 of the scrub bar 10 may not be hollow, but rather the body 12 may be solid and completely filled with the material used to construct the scrub bar 10. To that point, in some examples, the scrub bar 10 can be constructed from a polymeric material. Specifically, in some examples the scrub bar 10 can be constructed from a 100% food-grade or food-safe silicone material.

More specifically, in some examples, the scrub bar 10 can be constructed from a material mixture including silicone, colorant additives, and other additives. The specific material mixture can be altered to achieve the desired material and physical properties of the silicone for manufacturing and in-use purposes. For example, the material used to construct and produce the scrub bar 10 can include the 100% food-grade or food-safe silicone material mixed with a plurality of additives. In some examples, one additive can be a silicone thinner that is utilized to aid in degassing the liquid mixture, aid in flowing the material into a mold for producing the scrub bar 10, lower the hardness of the final produced scrub bar 10, and increase the pot life or working time of the silicone material. Further, in some examples, another additive could be a separate additive that is further intended to increase the pot life or working time of the silicone material by slowing the cure time of the silicone material. In addition, in some examples, a further additive could be a colorant additive that is configured to add different or desired colors to the silicone material and the overall scrub bar 10. It is to be understood that although a few additives are described above, the scrub bar 10 can be constructed from a material including more or less than the above described additives.

Referring to FIGS. 1, 2, and 8, in some examples, the scrub bar 10 can include the identification feature 16. The identification feature 16 can be letters, shapes, symbols, or numbers, among other options not specifically listed, that are utilized to identify the name and/or supplier of the scrub bar 10. Further, the identification feature 16 can be positioned on and extend outwards from the top surface 18 of the body 12 of the scrub bar 10. Therefore, the identification feature 16 can extend from the top surface 18 of the body 12 in a direction away from a center of the body 12 and the center of the overall scrub bar 10. In other words, the identification feature 16 can be described as being positioned on and extending from the top surface 18, such that the identification feature 16 is raised above or outwards from the top surface 18 of the body 12.

In the illustrated example, the identification feature 16 is positioned on an extends from the top surface 18 of the body 12. In other examples, the identification feature 16 could be positioned on and extend outwards from any of the other surfaces 20, 22, 24, 26 or 28 of the body 12 of the scrub bar 10. In addition, in the illustrated example the identification feature 16 recites the word “DOAP”, which indicates the name and/or supplier of the scrub bar 10. In other non-illustrated example, the identification feature 16 could recite or include letters, shapes, symbols, or numbers that recite or illustrate something other than “DOAP”. It is to be understood that the word “DOAP” is merely an example of an identification feature 16 that can be present on the scrub bar 10.

The scrub bar 10 further includes a plurality of nubs 14 extending from each of the top surface 18, the bottom surface 20, the front surface 22, the rear surface 24, the first side surface 26, and the second side surface 28. The plurality of nubs 14 can further be described as extending in a direction away from a center of the body 12 and the center of the overall scrub bar 10. As illustrated, the plurality of nubs 14 are positioned fully around the exterior surfaces of the body 12, except the location or position in which the identification feature 16 is located. As such, the plurality of nubs 14 almost entirely surround the outer or exterior surface of the body 12, except for the location in which the identification feature 16 is positioned. As illustrated in FIGS. 4 and 7, the body 12 can be described as including an upper half 12A and a lower half 12B separated by a medial plane MP. The medial plane MP being positioned an equal distance in the vertical direction from the top surface 18 and the bottom surface 20 of the body 12. Due to the inclusion of the identification feature 16 on the top surface 18 of the body 12, the upper half 12A and the lower half 12B of the body 12 can be described as being non-identical or non-mirrored about the medial plane MP. In some examples, the upper half 12A of the body 12 can include between 100 and 125 nubs 14 extending from the upper half 12A of the body 12, and the lower half 12B of the body 12 can include between 126 and 150 nubs extending from the lower half of the body. It is appreciated further than the upper half 12A and lower half 12B can be mirror images or identical or substantially identical. Each of the nubs 14, or one or more of the nubs, can preferably have a terminal end that is a flat surface, as shown for example in FIGS. 1-6.

When the scrub bar 10 is in use, the plurality of nubs 14 are configured to aid in collecting and removing the dough or other substance from the user's hands. In some examples, each of the plurality of nubs 14 extend from the body 12 at an angle ranging between 85 degrees and 95 degrees, with reference to the location in which each individual nub 14 connects to the outer surface of the body 12. In some examples, each of the plurality of nubs 14 can extend from the body 12 at an angle of 90 degrees. In some examples, each of the plurality of nubs 14 can extend in a normal orientation, or along a normal line (that is, perpendicular to a point of a curved surface of the body 12), from the surface of the body 12 from which a respective nub 14 extends. Further, each of the plurality of nubs 14 can be positioned and sized such that an individual nub 14 does not contact another individual nub 14 of the scrub bar 10. To achieve the aforementioned non-contact between the individual nubs 14, a spacing between each adjacent nub 14 of the plurality of nubs 14 ranges between 1 millimeter and 5 millimeters. In other examples, the spacing between each adjacent nub 14 of the plurality of nubs 14 can be less than 1 millimeter and/or more than 5 millimeters, as long as adjacent nubs 14 of the plurality of nubs 14 are in a non-contacting relationship. The spacing of the plurality of nubs 14 is such that it allows dough or other substances to be trapped between them during use. This spacing and design greatly enhances the scrub bars 10 efficacy compared to a much wider or much narrower spacing between the plurality of nubs 14.

In the illustrated example, each of the plurality of nubs 14 include a cylindrical shape with a circular cross-section when viewing in an axial direction along each of the plurality of nubs 14. In such an example, each of the plurality of nubs 14 can have a diameter that ranges between 1 millimeter and 10 millimeters. More specifically, each of the plurality of nubs 14 can have a diameter that ranges between 3 millimeters and 8 millimeters. Even more specifically, each of the plurality of nubs 14 can have a diameter that ranges between 4 millimeters and 6 millimeters. In other non-illustrated examples, each of the plurality of nubs 14 can have a different geometrical cross-sectional shape other than a circular cross-sectional shape, as described and illustrated. For example, each of the plurality of nubs 14 could include a square cross-sectional shape, a rectangular cross-sectional shape, a triangular cross-sectional shape, a hexagonal cross-sectional shape, or a cross (i.e., X-shape or plus-sign) cross-sectional shape, among other options not specifically listed.

Further, in some examples, each of the plurality of nubs 14 can extend from the outer surface of the body 12 a distance ranging between 1 millimeter and 10 millimeters. In other words, in some examples, each of the plurality of nubs 14 can have a height extending from the outer surface of the body 12 ranging between 1 millimeter and 10 millimeters. More specifically, in some examples, each of the plurality of nubs 14 can have a height ranging between 3 millimeters and 8 millimeters. Even more specifically, in some examples, each of the plurality of nubs 14 can have a height ranging between 5 millimeters and 6 millimeters. The exact height of each of the plurality of nubs 14 can be altered as desired to achieve the desired height and/or flexibility of the nubs 14. The flexibility or stiffness of the plurality of nubs 14 can also be altered by changing the diameter or thickness of the plurality of nubs 14. The desired flexibility or stiffness can be designed to be stiff enough to remove a substance from a user's hands, while at the same time being soft enough to be comfortable to the touch in the user's hands.

As illustrated in FIGS. 7-8, in some examples, each of the plurality of nubs 14 can include a hollow interior. The hollow interior can be included to aid in the flexibility of the plurality of nubs 14, and to reduce the overall weight of the scrub bar 10. Further, each of the plurality of nubs 14 can include a hollow interior based on the process used to produce the scrub bar 10, such as, for example, a molding process. In other non-illustrated examples, each of the plurality of nubs 14 can include a solid or filled interior, such that each of the plurality of nubs 14 do not include a hollow interior. Such an example aids in the stiffness of the plurality of nubs 14, preventing too much flexibility in the plurality of nubs 14. Further, each of the plurality of nubs 14 can include a solid or filled interior based on the process used to produce the scrub bar 10, such as, for example, a 3D printing or other additive manufacturing process.

In use, a user places their hands and the scrub bar 10 under running water or in a container filled with water, then the user rubs their hands on the scrub bar 10 and/or rubs the scrub bar 10 along all surfaces of their hands. The plurality of nubs 14 of the scrub bar 10 are utilized to pull the sticky dough or other substance from the user's hands. More specifically, the sticky dough or other substance is caught on and between the plurality of nubs 14 as the user rubs the scrub bar 10 along all surfaces of their hands. The sticky dough or other substance is pulled from the user's hands and the water easily washes the sticky dough or other substance from the scrub bar 10. As such, the scrub bar 10 is a cleaning device that aids in easily and efficiently removing sticky dough or other substances from a user's/baker's hands, reducing the time and effort typically associated with cleaning and removing dough from user's/baker's hands.

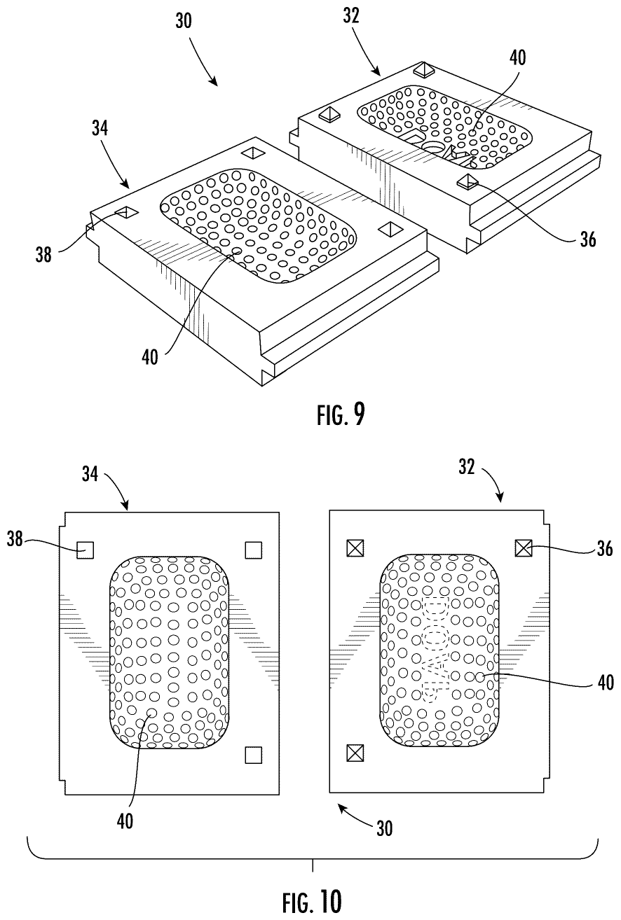

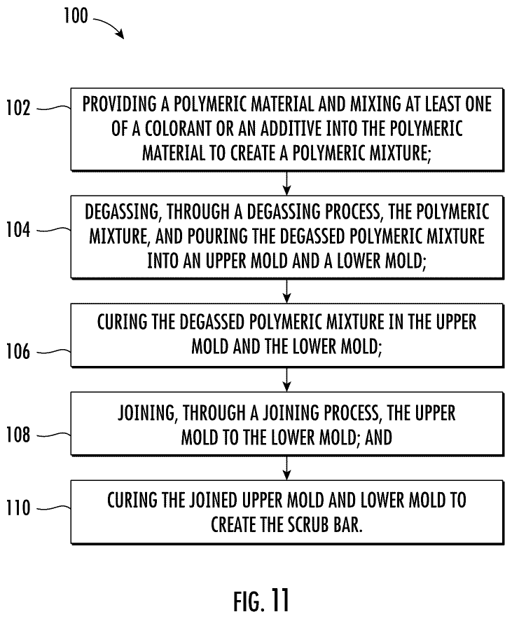

FIG. 9 is a perspective view of a mold assembly 30 utilized to produce the scrub bar 10. FIG. 10 is a top view of the mold assembly 30 illustrated in FIG. 9. In the illustrated example, the mold assembly 30 includes an upper mold 32 and a lower mold 34, which are utilized to produce the upper half 12A and the lower half 12B, respectively, of the body 12. The upper mold 32 includes at least one mold protrusion 36 and a plurality of nub molds 40. In the illustrated example, the upper mold 32 includes three mold protrusions 36. In other examples, the upper mold 32 can include more or less than three mold protrusions 36. The lower mold 34 includes at least one mold aperture 38 and a plurality of nub molds 40. In the illustrated example, the lower mold 34 includes three mold apertures 38. In other examples, the lower mold 34 can include more or less than three mold apertures 38. Generally, the number of mold protrusions 36 will be equal to the number of mold apertures 38. The at least one mold protrusion 36 of the upper mold 32 is shaped and size to mate with the at least one mold aperture 38 of the lower mold 34. As such, the upper mold 32 and the lower mold 34 can be assembled together, and the at least one mold protrusion 36 and the at least one mold aperture 38 ensure the molds 32, 34 are correctly assembled together.

The upper mold 32 and the lower mold 34 each include a cavity corresponding to the desired outer shape of the body 12 of the scrub bar 10. Further, the upper mold 32 and the lower mold 34 each include the plurality of nub molds 40 which are configured to create and shape the plurality of nubs 14 of the scrub bar 10. As such, each of the plurality of nub molds 40 corresponding to the desired outer shape of each of the plurality of nubs 14 of the scrub bar 10. Therefore, when a polymeric or other material is poured into the upper mold 32 and the lower mold 34 of the mold assembly 30, the material flows into plurality of nub molds 40 and the overall cavities of the upper mold 32 and the lower mold 34 to create and produce the overall shape of the scrub bar 10.

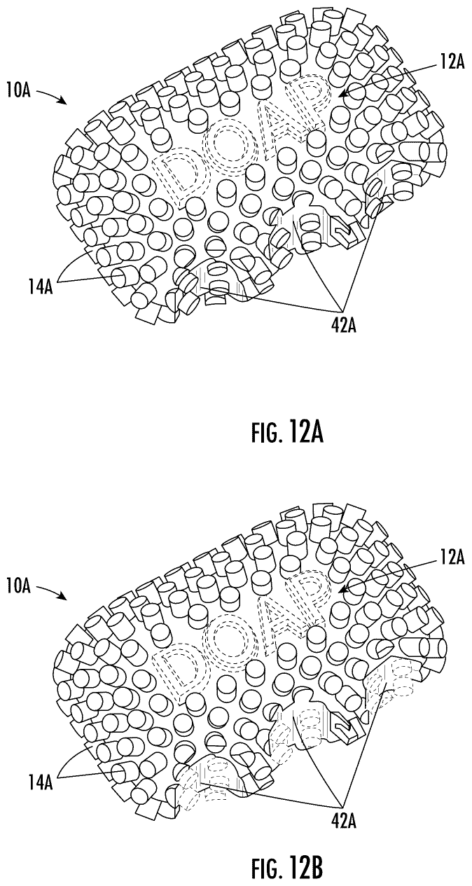

FIG. 11 is a flow chart illustrating a method 100 including steps 102-110 for producing the scrub bar 10 illustrated in FIGS. 1-8 using the mold assembly 30 illustrated in FIGS. 9-10. It is to be understood that steps 102-110 are specifically recited in the example method 100, but in another example the method 100 could include more or less than steps 102-110. As such, method 100 is an example method for producing the scrub bar 10, and it is to be understood that other methods can be utilized to produce the scrub bar 10.

Therefore, the method 100 can include one or more of steps 102-110, discussed below. At step 102, a polymeric material is provided and the polymeric material is mixed with at least one of a colorant or an additive to create a polymeric mixture. In some examples, the polymeric material can be a food-grade silicone material. At step 104, the polymeric mixture is degassed using a degassing process, and the degassed polymeric mixture is then poured into the upper mold 32 and the lower mold 34 of the mold assembly 30. In some examples, the degassing process can be performed in a vacuum chamber. At step 106, the degassed polymeric mixture is then cured for a specified amount of time in the upper mold 32 and the lower mold 34 of the mold assembly 30.

Next, at step 108, the upper mold 32 and the lower mold 34 (along with the semi-cured polymeric mixture) are joined together through a joining process. At step 110, the joined upper mold 32 and lower mold 34 are further cured to create the scrub bar 10. The method 100 can further include a method step after curing the joined upper mold 32 and lower mold 34, which can include removing the scrub bar 10 from the upper mold 32 and the lower mold 34 and then trimming excess material positioned along a joining seam of the upper mold 32 and the lower mold 34 to produce a final, cleaned-up version of the scrub bar 10. As discussed, the disclosed molding process using the mold assembly 30 is only one example of producing the scrub bar 10. As such, the present disclosure is not limited to such a singular method for producing the scrub bar 10. For example, 3D printing or other additive manufacturing processes could be used to produce the scrub bar 10, among other manufacturing methods or processes not specifically listed.

The scrub bar 10 of the present disclosure is a cleaning device that aids in easily and efficiently removing dough from baker's hands, reducing the time and effort typically associated with cleaning and removing dough from baker's hands. As such, the scrub bar 10 can be described as a “dough soap” for bakers to utilize to clean their hands. The scrub bar 10 can include a plurality of nubs 14 that facilitate removing the dough or other substance from the baker's hands. In some examples, the scrub bar 10 can be made from food-grade/food-safe silicone and the scrub bar 10 can be dishwasher safe to aid in ease of use and cleaning. The scrub bar 10 is utilized to quickly and easily remove sticky dough from a baker's hands, providing advantages over previous products and techniques for removing dough from a baker's hands, as will be appreciated by persons having ordinary skill in the art.

Although the preceding disclosure focuses on the scrub bar 10 being utilized to remove dough or other substances from a user's hands, it is to be understood that the scrub bar 10 can be used for a variety of other purposes. Several examples of other potential uses of the device (scrub bar 10) are described below.

In one example, another potential use of the device (referred to as the scrub bar 10) could be a therapeutic device, such as a hand strengthening, rehabilitation, and/or medical device for use in, for example, physical therapy applications. In such an example, the device (scrub bar 10) can be utilized to aid patients in, for example, pain relief, rebuilding hand strength and coordination after a stroke, burn, or other serious injury. The device could primarily be used as a therapeutic medical device in clinical rehabilitation facilities and hospital settings, and the device could also be sold in retail outlets. Accordingly, the overall exterior shape of the device (scrub bar 10) could be modified to comfortably fit within a patient's hands while keeping the plurality of nubs 14, such as an ergonomic design with a wave-like or similar overall design to accommodate fingers or a hand shape. Further, varying, such as three or more different levels of pliability corresponding to different colored devices (scrub bar 10) could be provided, with each level of pliability increasing in a specific shore hardness to accommodate a wide range of patient rehabilitation needs. The flexibility of the nubs can be adjusted as needed to provide for more or less elasticity upon manipulation.

In another example, another potential use of the device (scrub bar 10) could be a therapeutic “fidget” and self-soothing device for use within neurodiverse persons including those with ADHD, SPS (sensory processing sensitivity), and autistic spectrum conditions. In such an example, the device (scrub bar 10) could be utilized to sooth and calm neurodiverse persons or any neurotypical person in need of stress or anxiety release. In this example, the overall exterior shape of the device (scrub bar 10) could be modified to comfortably fit within a patient's hands when in use and to comfortably fit inside a user's pocket when not in use, while keeping the characteristic plurality of nubs 14. Further, the hardness or pliability of the device (scrub bar 10) could be modified to increase tactile sensation with enhanced compression characteristics, further aiding in the soothing and calming effects.

In yet another example, another potential use of the device (scrub bar 10) could be a produce scrubber/cleaner which is utilized to clean dirt, wax, and other residues from fruits and vegetables, among other foods not specifically listed. In another somewhat similar example, the device (scrub bar 10) could also be used as a pet brush or grooming device for fur/hair removal. In such an example, the device (scrub bar 10) could be used to brush and groom the coat of pets/animals to remove any shedding hair/fur. In another somewhat related example, the device (scrub bar 10) could be used as a cosmetic, makeup and hair products cleaner for the user's hands. In such an example, the device (scrub bar 10) could be used to clean the user's hands of makeup and other cosmetic products such as hair products, waxes, and gels, among other products not specifically listed. In each of the aforementioned examples, the overall size and shape of the device (scrub bar 10) could be modified as desired to achieve the most ergonomically efficient and convenient design for each specific application or use. Further, in each of the aforementioned examples, the characteristic plurality of nubs 14 would be maintained to aid in each of the different uses.

In another example, another potential use of the device (scrub bar 10) could be a device used to promote mental clarity, concentration, and greater results when held/manipulated by people, including: students during studying (as a study aid), writers to overcome writers block and/or promote the flow of ideas, musicians and artists to promote creativity, and people of all types in need of mental focus, clarity, and concentration. In this example, the overall exterior shape of the device (scrub bar 10) could be modified to comfortably fit within a user's hands when in use, while keeping the characteristic plurality of nubs 14. Further, the hardness or pliability of the device (scrub bar 10) could be modified to increase tactile sensation with enhanced compression characteristics, further aiding in the device's beneficial effects.

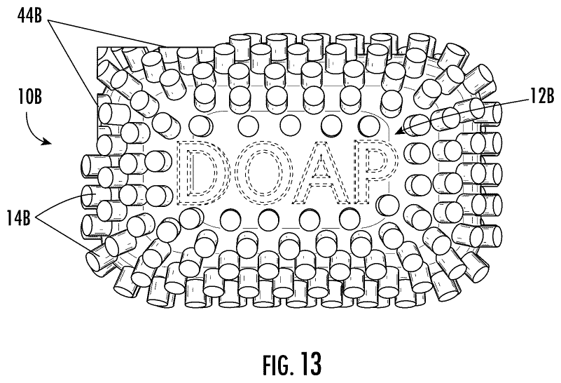

FIG. 12A is a perspective view of a scrub bar 10A according to another embodiment of the present disclosure. FIG. 12B is another perspective view of the scrub bar 10A with the nubs 14A shown in dashed or phantom lines for clarity purposes. The scrub bar 10A is substantially similar to the scrub bar 10, described with reference to FIGS. 1-11, and therefore the disclosure regarding the scrub bar 10 equally applies to the scrub bar 10A in FIGS. 12A-12B, unless otherwise stated. As such, to avoid redundancy, only the differences between the scrub bar 10 and the scrub bar 10A will be described in detail. Referring to FIGS. 12A-12B, the scrub bar 10A includes scalloped or wave-like indentations 42A extending into the body 12A of the scrub bar 10A. Specifically, the scrub bar 10A includes three scalloped or wave-like indentations 42A extending into a side surface of the body 12A of the scrub bar 10A, which indentations 42A are configured to be shaped and sized to receive the fingers of the user holding the scrub bar 10A.

It is to be understood that although the indentations 42A are illustrated on one specific side of the scrub bar 10A, the indentations 42A can be positioned along any of the front, rear, first side, and/or second side of the scrub bar 10A. Additionally, it is to be understood that although FIGS. 12A-12B illustrate three indentations 42A, in other examples the scrub bar 10A can include more or less than three indentations 42A. As illustrated, in some examples, each of the indentations 42A can include a plurality of nubs 14A disposed within each of the indentations 42A. In other examples, the indentations 42A may not include the nubs 14A. The indentations 42A are configured to aid in the ease of gripping and holding the scrub bar 10A, as well as aiding in cleaning the side surfaces of the user's fingers. It is contemplated that other wave-like, scalloped, or similar indentations or openings can be employed, including deeper indentations, indentations having different curves, and additional numbers of indentations to provide for a grip, such as a “pistol-like” grip. An opening may also be provided completely through the body 12, to provide either for a finger to be inserted, or to include a handing element such as a string, or rope, or elastic band.

FIG. 13 is a perspective view of a scrub bar 10B according to yet another embodiment of the present disclosure. The scrub bar 10B is substantially similar to the scrub bar 10, described with reference to FIGS. 1-11, and therefore the disclosure regarding the scrub bar 10 equally applies to the scrub bar 10B in FIG. 13, unless otherwise stated. As such, to avoid redundancy, only the differences between the scrub bar 10 and the scrub bar 10B will be described in detail. Referring to FIG. 13, the scrub bar 10B includes a corner feature 44B on one of the corners of the body 12B of the scrub bar 10B. In some examples, as illustrated, the corner feature 44B may only be included on one of the corners of the body 12B of the scrub bar 10B. In other examples, the corner feature 44B may be included on more than one of the corners of the body 12B of the scrub bar 10B. In some examples, the corner feature 44B can be a 90-degree corner or edge that is cut into or formed in the body 12B and/or the nubs 14B of the scrub bar 10B. In other examples, the corner feature 44B can be more or less than a 90-degree corner of edge.

The corner feature 44B can be used to efficiently clean dough and other debris from corners and hard to reach areas of dough bins, sinks, jars, and other containers or surfaces, as will be appreciated by a person having ordinary skill in the art. It is to be understood that although the previous disclosure focuses on the scrub bars 10, 10A, and 10B being used to clean a substance (such as bakery dough) from a user's hands, the scrub bars 10, 10A, and 10B can also be used to clean any surface with the substance (such as bakery dough) on it, such as baking surfaces, cookware, pots, pans, countertops, and sinks, among other options not specifically listed.

Having thus described the present embodiments in detail, it is to be appreciated and will be apparent to those skilled in the art that many physical changes, only a few of which are exemplified in the detailed description of the disclosure, could be made without altering the inventive concepts and principles embodied therein.

It is also to be appreciated that numerous embodiments incorporating only part of the preferred embodiment are possible which do not alter, with respect to those parts, the inventive concepts and principles embodied therein. The present embodiment and optional configurations are therefore to be considered in all respects as exemplary and/or illustrative and not restrictive, the scope of the disclosure being indicated by the appended claims rather than by the foregoing description, and all alternate embodiments and changes to this embodiment which come within the meaning and range of equivalency of said claims are therefore to be embraced therein.

### LOG OF REFERENCE NUMERALS

10 Scrub Bar
12 Body
12A Upper Half
12B Lower Half
14 Nubs
16 Identification Feature
18 Top Surface
20 Bottom Surface
22 Front Surface
24 Rear Surface
26 First Side Surface
28 Second Side Surface
30 Mold Assembly
32 Upper Mold
34 Lower Mold
36 Mold Protrusion
38 Mold Aperture
40 Nub Molds
42A Indentations
44B Corner Feature
MP Medial Plane

What is claimed is:

1. A scrub bar comprising:
a body including a top surface, a bottom surface, a front surface, a rear surface, a first side surface, and a second side surface; and
a plurality of nubs extending from each of the top surface, the bottom surface, the front surface, the rear surface, the first side surface, and the second side surface, wherein each of the plurality of nubs extend in a direction away from a center of the body.

2. The scrub bar of claim 1, wherein the body comprises a rectangular prism shape with each edge and corner of the rectangular prism being rounded.

3. The scrub bar of claim 1, wherein the body includes a solid or filled interior.

4. The scrub bar of claim 1, wherein the body includes an upper half and a lower half separated by a medial plane positioned an equal distance from the top surface and the bottom surface of the body, the upper half and the lower half of the body being non-identical or non-mirrored about the medial plane.

5. The scrub bar of claim 4, wherein the upper half of the body includes between 100 and 125 nubs extending from the upper half of the body, and the lower half of the body includes between 126 and 150 nubs extending from the lower half of the body.

6. The scrub bar of claim 1, wherein each of the plurality of nubs extend from the body at an angle ranging between 85 degrees and 95 degrees with reference to each individual nubs connection location to the body.

7. The scrub bar of claim 1, wherein a spacing between each adjacent nub of the plurality of nubs ranges between 1 millimeter and 5 millimeters.

8. The scrub bar of claim 1, wherein each of the plurality of nubs include a cylindrical shape with a circular cross section viewing in an axial direction of each of the plurality of nubs.

9. The scrub bar of claim 8, wherein a diameter of each of the plurality of nubs ranges between 1 millimeter and 10 millimeters.

10. The scrub bar of claim 1, wherein each of the plurality of nubs extend from the body a distance ranging between 1 millimeter and 10 millimeters.

11. The scrub bar of claim 1, further comprising an identification feature extending from the top surface of the body.

12. The scrub bar of claim 11, wherein the identification feature includes letters, shapes, symbols, or numbers.

13. The scrub bar of claim 1, wherein both the body and the plurality of nubs are constructed from a polymeric material.

14. The scrub bar of claim 1, wherein both the body and the plurality of nubs are constructed from a food-grade silicone material.

15. The scrub bar of claim 1, wherein the scrub bar is configured to remove a substance from a user's hands.

16. The scrub bar of claim 15, wherein the substance is an edible dough.

17. A method of producing a scrub bar for removing a substance from a user's hands, the method comprising:
providing a polymeric material and mixing at least one of a colorant or an additive into the polymeric material to create a polymeric mixture;
degassing, through a degassing process, the polymeric mixture, and pouring the degassed polymeric mixture into an upper mold and a lower mold;
curing the degassed polymeric mixture in the upper mold and the lower mold;
joining, through a joining process, the upper mold to the lower mold; and
curing the joined upper mold and lower mold to create the scrub bar.

18. The method of claim 17, further comprising, after curing the joined upper mold and lower mold:
removing the scrub bar from the upper mold and the lower mold; and
trimming excess material positioned along a joining seam of the upper mold and the lower mold to produce a final scrub bar.

19. The method of claim 17, wherein the degassing process is performed in a vacuum chamber.

20. The method of claim 17, where the polymeric material is a food-grade silicone material.
